(19) United States
(12) Patent Application Publication
(10) Pub. No.: US 2025/0368560 A1
(43) Pub. Date: Dec. 4, 2025

(54) IN SITU POLYMER COATING REFRACTIVE INDEX MODIFICATION

(71) Applicant: Lumentum Operations LLC, San Jose, CA (US)

(72) Inventors: Alen BUCAR, Trebnje (SI); Aljaž RAMŠAK, Ljubljana (SI)

(21) Appl. No.: 18/811,017

(22) Filed: Aug. 21, 2024

Related U.S. Application Data
(60) Provisional application No. 63/653,060, filed on May 29, 2024.

(51) Int. Cl. C03B 37/02; C03B 37/025; C03C 13/04; C03C 25/105

(52) U.S. Cl. CPC C03B 37/02; C03B 37/025; C03C 13/04; C03C 25/105

(57) ABSTRACT

A method of manufacturing an optical fiber includes drawing a glass fiber from a glass preform that is arranged in a glass furnace; and while drawing the glass fiber out of the glass furnace: applying a fiber coating to the glass fiber; and applying one or more dopants to a base material of the fiber coating to modify a refractive index of the fiber coating.

### CROSS-REFERENCE TO RELATED APPLICATION

This Patent Application claims priority to U.S. Provisional Patent Application No. 63/653,060, filed on May 29, 2024, and entitled “IN SITU POLYMER COATING REFRACTIVE INDEX MODIFICATION.” The disclosure of the prior Application is considered part of and is incorporated by reference into this Patent Application.

### TECHNICAL FIELD

The present disclosure relates generally to in situ systems and methods for manufacturing an optical fiber coating with a modified refractive index.

### BACKGROUND

An optical fiber is a flexible glass or plastic fiber that can transmit light. Such optical fibers find wide usage in fiber-optic communications, where optical fibers enable transmission over longer distances and at higher bandwidths (data transfer rates) than electrical cables. Optical fibers are often used instead of metal wires because signals travel along optical fibers with less loss and are immune to electromagnetic interference. Optical fibers may also be used for illumination and imaging, and are often wrapped in bundles so that optical fibers may be used to carry light into, or images out of confined spaces, as in the case of a fiberscope. Specially designed fibers are also used for a variety of other applications, such as fiber optic sensors and fiber lasers.

Glass optical fibers are typically made by drawing an optical fiber from a glass perform arranged in a furnace, while plastic fibers can be made either by drawing or by extrusion. Optical fibers typically include a core surrounded by a transparent cladding material with a lower index of refraction. Light is kept in the core by the phenomenon of total internal reflection which causes the optical fiber to act as a waveguide. Optical fibers that support many propagation paths or transverse modes are called multi-mode fibers, while optical fibers that support a single mode are called single-mode fibers.

### SUMMARY

In some implementations, a method of manufacturing an optical fiber includes drawing a glass fiber from a glass preform that is arranged in a glass furnace; and while drawing the glass fiber out of the glass furnace: applying a fiber coating to the glass fiber; and applying one or more dopants to a base material of the fiber coating to modify a refractive index of the fiber coating.

In some implementations, a method of manufacturing an optical fiber includes drawing a glass fiber from a glass preform that is arranged in a glass furnace; while drawing the glass fiber out of the glass furnace, applying a fiber coating to the glass fiber to form a coated glass fiber; and exposing the coated glass fiber to a dopant medium containing one or more dopants such that the one or more dopants diffuse into a base material of the fiber coating to modify a refractive index of the fiber coating.

In some implementations, a manufacturing system for manufacturing an optical fiber includes a glass furnace configured to heat a glass preform from which a glass fiber is to be drawn; a coating doping station configured to mix a base material of a fiber coating with a dopant medium containing one or more dopants to produce a doped base material having a modified refractive index based on the one or more dopants; a coating applicator coupled to the coating doping station for receiving the doped base material from the coating doping station, wherein the coating applicator is configured to, while the glass fiber is being drawn from the glass furnace, apply the doped base material to the glass fiber to form a coated glass fiber; and an ultraviolet (UV) light curing station configured to at least partially cure the doped base material of the coated glass fiber.

In some implementations, a manufacturing system for manufacturing an optical fiber includes a glass furnace configured to heat a glass preform from which a glass fiber is to be drawn; a coating applicator configured to, while the glass fiber is being drawn from the glass furnace, apply a fiber coating to the glass fiber to form a coated glass fiber; a coating doping chamber configured to, while the glass fiber is being drawn from the glass furnace, expose the coated glass fiber to a dopant medium containing one or more dopants such that the one or more dopants diffuse into a base material of the fiber coating to modify a refractive index of the fiber coating; and a UV light curing station arranged downstream from the coating doping chamber, wherein the UV light curing station is configured to apply a UV light to the coated glass fiber to at least partially cure the fiber coating.

In some implementations, a manufacturing system for manufacturing an optical fiber includes a glass furnace configured to heat a glass preform from which a glass fiber is to be drawn; a coating applicator configured to, while the glass fiber is being drawn from the glass furnace, apply a fiber coating to the glass fiber to form a coated glass fiber; a UV light curing station arranged downstream from the coating applicator, wherein the UV light curing station is configured to apply a UV light to the coated glass fiber to at least partially cure the fiber coating; and a coating doping chamber arranged downstream from the UV light curing station, wherein the coating doping chamber is configured to expose the coated glass fiber to a dopant medium containing one or more dopants such that the one or more dopants diffuse into a base material of the fiber coating to modify a refractive index of the fiber coating.

### BRIEF DESCRIPTION OF THE DRAWINGS

FIG. 1 shows a manufacturing system for manufacturing an optical fiber according to one or more implementations.

FIG. 2 shows a manufacturing system for manufacturing an optical fiber according to one or more implementations.

FIG. 3 shows a manufacturing system for manufacturing an optical fiber according to one or more implementations.

FIG. 4 is a flowchart of an example process associated with in situ polymer coating refractive index modification.

FIG. 5 is a flowchart of an example process associated with in situ polymer coating refractive index modification.

### DETAILED DESCRIPTION

The following detailed description of example implementations refers to the accompanying drawings. The same reference numbers in different drawings may identify the same or similar elements.

A fiber coating may be applied to a glass fiber during manufacturing of an optical fiber. Fiber coatings are currently supplied with specific refractive indexes. When a fiber coating is applied to a glass fiber, the properties of the optical fiber may be altered. The fiber coatings are typically shipped from fiber coating manufacturers (e.g., fiber coating suppliers) to optical fiber manufacturers, which apply the fiber coatings to glass fibers during optical fiber production.

Since low (and high) refractive index materials often include chemicals with significant environmental impact, there is an effort to significantly reduce a use of refractive index materials that include these chemicals. There is currently no way of producing optical and laser fibers without the use of such fiber coatings (e.g., polymer coatings). As a result, a solution may be desired in case regulatory restrictions prohibit procurement of certain materials.

In addition, the fiber coatings used in optical fiber production are supplied by only a few companies, some of which are located in (potentially) geopolitically volatile regions. Thus, new supply chains may be needed to stabilize a supply of fiber coatings.

Using off-the-shelf fiber coatings also means that optical fiber designers must work using coating specifications that the optical fiber designers cannot influence. As a result, optical fiber designs may be encumbered by using only those fiber coatings (and respective refractive indexes) available on the market. In other words, there may be some optical fiber designs that are out of reach since there is no supporting fiber coating material available that would be compatible with the optical fiber designs. Thus, current fiber coatings may restrict development and innovation of new optical fiber designs since the fiber coating materials (and respective refractive indexes) available may be limited.

In addition, a shelf life of fiber coatings may also be an inconvenience for production of optical fibers where irregular use of specific fiber coatings is needed, such as for specialty optical fibers. In other words, specialty optical fibers may be produced less frequently. As a result, the specific fiber coatings used for making the specialty optical fibers may be used less frequently. In between production batches, the specific fiber coatings may degrade in quality or expire, which may add to production costs due to a need to acquire a new supply of fiber coating material.

Some implementations are directed to fiber coatings, optical fibers, and a method of manufacturing the fiber coatings and optical fibers with flexible design via an in situ polymer coating refractive index modification process. The method may enable production of a fiber coating (e.g., a polymer coating) with a desired property (e.g., to provide a fiber coating with a desired refractive index) while an optical fiber is being produced. The production of fiber coatings may be adapted for any type of optical fiber. A method of manufacturing an optical fiber may include drawing a glass fiber from a glass preform that is arranged in a glass furnace; and, while drawing the glass fiber out of the glass furnace: applying a fiber coating to the glass fiber; and applying one or more dopants to a base material (e.g., a fiber coating material) of the fiber coating to modify a refractive index of the fiber coating. Thus, the base material of the of the fiber coating may be produced with a specific refractive index while the glass fiber is being drawn out of the glass furnace from the glass preform. Moreover, the fiber coating, with the specific refractive index, may be applied to the glass fiber while the glass fiber is being drawn out of the glass furnace from the glass preform. The specific refractive index of the fiber coating may be adapted to obtain the desired refractive index for the optical fiber. Thus, the refractive index of the fiber coating may be modified in situ to a manufacturing processor of the optical fiber (e.g., at an optical fiber manufacturing site), which may provide a greater flexibility in design choices and less reliance on a limited number of available fiber coatings and suppliers.

A method of manufacturing an optical fiber may include drawing a glass fiber from a glass preform that is arranged in a glass furnace; while drawing the glass fiber out of the glass furnace, applying a fiber coating to the glass fiber to form a coated glass fiber; and exposing the coated glass fiber to a dopant medium containing one or more dopants such that the one or more dopants diffuse into a base material of the fiber coating to modify a refractive index of the fiber coating. The specific refractive index of the fiber coating may be adapted to obtain the desired refractive index of the optical fiber. Thus, the refractive index of the fiber coating may be modified in situ to a manufacturing processor of the optical fiber (e.g., at an optical fiber manufacturing site), which may provide a greater flexibility in design choices and less reliance on a limited number of available fiber coatings and suppliers.

Some implementations are directed to fiber coatings and a method of manufacturing the fiber coatings using a base material without regulatory restrictions (such as current coating base materials) and modifying a structure or composition of the base material during and/or after application of the base material on an optical fiber in such a way that the base material achieves desired optical properties and complies with regulatory requirements. The base material may be produced to be devoid of chemicals that are currently being used that may be harmful to the environment. In-situ coating preparation may enable specifically tailored optical properties, enabling new optical fiber designs. One or more fiber coatings may be manufactured at the optical fiber manufacturing site on an as-needed basis such that a shelf life of the fiber coatings is less of a concern.

Thus, some implementations are directed to an innovative method and system for in situ process of polymer coating refractive index modification for glass fiber coatings. The in situ process may eliminate a need for a separate offline doping step, reduce reliance on external suppliers, and enable more design and property tailoring flexibility.

A first approach for in situ refractive index modification of a fiber coating may include, first, doping a base material prior to applying the base material to an optical fiber. The base material may be mixed with a dopant source (gas or liquid) before the base material is applied to the optical fiber, by either mixing or bubbling through. A doped base material may be produced with desired optical properties (e.g., a desired refractive index). The doped base material may then be applied to the optical fiber as a fiber coating. The base material may be an acrylate. The base material (e.g., acrylate) may be mixed with one or more doping elements in a receptacle or vessel just before use, when the fiber coating is prepared, and then may be applied to the optical fiber during a draw process of the optical fiber. Once applied to the optical fiber, the fiber coating may be cured or semi-cured (e.g., fully or partially cured) onto the optical fiber.

A second approach may include, first, applying a base material to an optical fiber as a fiber coating (e.g., a base coating) to produce a coated optical fiber. Then, applying a dopant medium in gaseous form to the coated optical fiber. As a result, the fiber coating may be doped through diffusion of one or more doping elements prior to the fiber coating being cured (e.g., solidified) or semi-cured (e.g., partially cured). The fiber coating may be cured or semi-cured after the fiber coating has been doped with the doping element.

The optical fiber may be drawn, then coated with base coating material (e.g., acrylate), and then the coated optical fiber may be exposed to a gaseous doping element (or doping element species) such that the doping element diffuses into the base coating material prior to the base coating material being cured. A time duration required for diffusion, a concentration of the doping element in a doping atmosphere, a temperature, and a desired result (e.g., a desired refractive index), are all influential parameters for controlling the process.

A third approach may include, first, applying a base material to an optical fiber as a fiber coating (e.g., a base coating) to produce a coated optical fiber. Then, at least partially curing the fiber coating onto the optical fiber (e.g., fully or partially curing). Then, the coated optical fiber may be exposed to a dopant medium (e.g., gas or liquid) having one or more dopants such that the one or more dopants diffuse into the base coating material, thereby modifying the refractive index of the base coating material and the optical fiber. A time duration required for diffusion, a concentration of a doping element in a doping atmosphere, a temperature, and a desired result (e.g., a desired refractive index), are all influential parameters for controlling the process. If the fiber coating has only been partially cured, the fiber coating may then be fully cured onto the optical fiber.

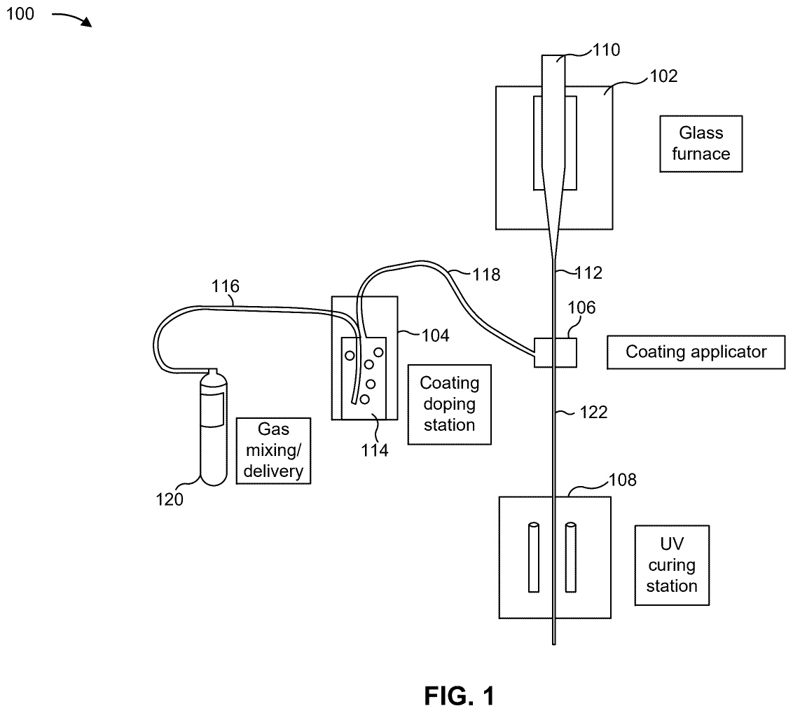

FIG. 1 shows a manufacturing system 100 for manufacturing an optical fiber according to one or more implementations. The manufacturing system 100 may include a glass furnace 102, a coating doping station 104, a coating applicator 106, and a UV light curing station 108.

The glass furnace 102 may be configured to heat a glass preform 110 from which a glass fiber 112 is to be drawn or pulled. The glass fiber 112 may be drawn from the glass preform 110 in a continuous manner.

The coating doping station 104 may mix a base material 114 of a fiber coating with a dopant medium 116 containing one or more dopants to produce a doped base material 118 having a modified refractive index based on the one or more dopants. The dopant medium 116 and the doped base material 118 may be transferred through respective conduits. The dopant medium 116 may be a gas or a liquid that is provided by a delivery source 120. The coating doping station 104 may include a receptacle used for mixing the base material 114 with the dopant medium 116.

The base material 114 may be a polymer material, such as a UV curable acrylate resin. The one or more dopants may include at least one of fluorine, boron, phosphorous, or chlorine. In other words, the dopant medium 116 may be a compound that includes fluorine, boron, phosphorous, and/or chlorine. For example, the one or more dopants may include at least one of fluorine, boron, or phosphorous to decrease the refractive index of the fiber coating. In some implementations, fluorine, diborane, or phosphine may be used to decrease the refractive index of the base material 114 of the fiber coating. Alternatively, the dopant medium 116 may include at least one of sulfur hexafluoride, silicon tetrafluoride, or titanium tetrachloride to increase the refractive index of the base material 114 of the fiber coating.

The coating applicator 106 may be arranged downstream from the glass furnace 102 and upstream from the UV light curing station 108 along a length of the glass fiber 112. The coating applicator 106 may be coupled to the coating doping station 104 for receiving the doped base material 118 from the coating doping station 104. The glass fiber 112 may be pulled through the coating applicator 106. The coating applicator 106 may, while the glass fiber 112 is being drawn from the glass furnace 102, apply the doped base material 118 to the glass fiber 112 to form a coated glass fiber 122.

The coated glass fiber 122 may be pulled through the UV light curing station 108. The UV light curing station 108 may at least partially cure the doped base material 118 of the coated glass fiber 122. The UV light curing station 108 may be configured to fully cure the doped base material 118 of the coated glass fiber 122, or partially cure (e.g., semi-cure) the doped base material 118 of the coated glass fiber 122. Whether the doped base material 118 is partially cured or fully cured may depend on an amount of time (e.g., an exposure time) the doped base material 118 is exposed to UV light. The exposure time may depend on a rate at which the glass fiber 112 is drawn from the glass furnace 102. Thus, a UV-curable acrylate resin with a desired doping may be cured onto the glass fiber 112.

In some implementations, one or more process stages may be repeated. For example, one or more additional coating doping stations 104, coating applicators 106, and/or UV light curing stations 108 may be provided following (e.g., downstream from) the UV light curing station 108. For example, while FIG. 1 illustrates one layer (e.g., one application) of fiber coating, the manufacturing system 100 may include multiple coatings, multiple dopings, and/or multiple UV light curing stations. Thus, another coating doping station, coating applicator, and UV light curing station may be provided for each layer of fiber coating. Multiple stations can be applied on a draw tower if multiple coating layers are desired.

The manufacturing system 100 provides an in situ process for modifying the refractive index of the fiber coating during manufacturing of the optical fiber (e.g., while the glass fiber 112 is being drawn from the glass furnace 102).

In general, the manufacturing system 100 may include a doping element source, capable of producing radicals or ions. Fluorine can be used to replace hydrogen atoms in a polymer matrix. Gaseous precursors for decreasing a refractive index may include fluorine gas. Additionally, or alternatively, a boron compound, such as diborane, or a phosphorous compound, such as phosphine, may be used as a doping element to reduce the refractive index. Gaseous precursors for increasing a refractive index may include, but not limited to, sulfur hexafluoride, silicon tetrafluoride, and titanium tetrachloride.

The manufacturing system 100 may include a precise delivery mechanism for introducing the doping element directly onto and/or into a polymer fiber coating. The manufacturing system 100 may include a controlled and monitored environment ensuring safety and optimal adjustment of doping parameters. The manufacturing system 100 may include a light curing station that cures a doped polymer fiber coating. The process may be continuously monitored to ensure consistent results and safety of operators and machines.

As indicated above, FIG. 1 is provided as an example. Other examples may differ from what is described with regard to FIG. 1.

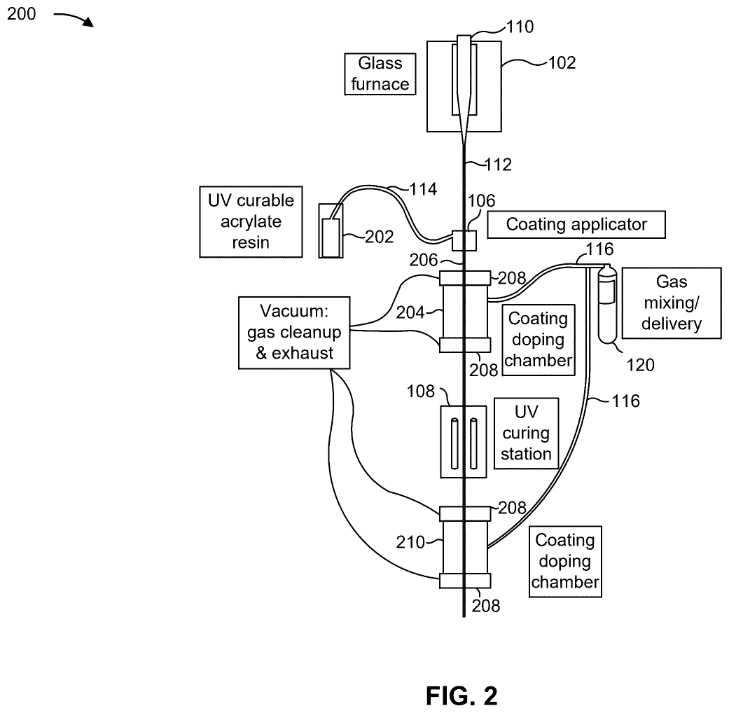

FIG. 2 shows a manufacturing system 200 for manufacturing an optical fiber according to one or more implementations. The manufacturing system 200 may include the glass furnace 102, the coating applicator 106, the UV light curing station 108, and the delivery source 120. In addition, the manufacturing system 200 may include a fiber coating source 202 (e.g., a base material source) and a coating doping chamber 204.

The glass furnace 102 may heat the glass preform 110 from which the glass fiber 112 is to be drawn or pulled. The glass fiber 112 may be drawn from the glass preform 110 in a continuous manner.

The coating applicator 106 may be coupled to the fiber coating source 202 for receiving the base material 114 from the fiber coating source 202. The fiber coating source 202 may include a receptacle that contains the base material 114. The coating applicator 106 may, while the glass fiber 112 is being drawn from the glass furnace 102, apply a fiber coating (e.g., the base material 114) to the glass fiber 112 to form a coated glass fiber 206.

The coating doping chamber 204 may be arranged downstream from the coating applicator 106 along the length of the glass fiber 112. The coating doping chamber 204 may be coupled to the delivery source 120 for receiving the dopant medium 116 from the delivery source 120. The dopant medium 116 may be delivered to the coating doping chamber 204 in a gaseous form. Additionally, the coating doping chamber 204 may receive the coated glass fiber 206 as the glass fiber 112 is being drawn from the glass furnace 102. The coated glass fiber 206 may be pulled through the coating doping chamber 204. The coating doping chamber 204 may, while the glass fiber 112 is being drawn from the glass furnace 102, expose the coated glass fiber 206 to the dopant medium 116 containing one or more dopants such that the one or more dopants diffuse into a base material 114 of the fiber coating to modify a refractive index of the fiber coating. Thus, the refractive index of the fiber coating of the coated glass fiber 206 may be modified while the fiber coating is on the glass fiber 112. In other words, the refractive index of the coated glass fiber 206 may be modified after the fiber coating is applied to the glass fiber 112.

Additionally, vacuum chambers 208 may be provided on both ends of the coating doping chamber 204. The vacuum chambers 208 may be used for gas cleanup and exhaust.

The UV light curing station 108 may be arranged downstream from the coating doping chamber 204. The UV light curing station 108 may apply a UV light to the (doped) coated glass fiber to at least partially cure the fiber coating.

Additionally, a coating doping chamber 210 may be arranged downstream from the UV light curing station 108 such that UV light is applied to the coated glass fiber 206 to at least partially cure the fiber coating prior to the coating doping chamber 210 exposing the coated glass fiber 206 to the dopant medium 116. The coating doping chamber 210 may be similar to the coating doping chamber 204. Thus, the coating doping chamber 210 may, while the glass fiber 112 is being drawn from the glass furnace 102, expose the coated glass fiber 206 to the dopant medium 116 containing one or more dopants such that the one or more dopants diffuse into the base material 114 of the fiber coating to modify a refractive index of the fiber coating. For example, the coating doping chamber 210 may receive a glass fiber that has a partially cured fiber coating. The coating doping chamber 210 may expose the coated glass fiber to the dopant medium while the glass fiber 112 is being drawn from the glass furnace 102.

In some implementations, the coating doping chamber 210 may be provided in lieu of the coating doping chamber 204. In other words, the coating doping chamber 204 may not be provided. Instead, the coating doping chamber 210 may expose the coated glass fiber 206 to the dopant medium 116 containing one or more dopants such that the one or more dopants diffuse into the base material 114 of the fiber coating to modify the refractive index of the fiber coating. Thus, the UV light curing station 108 may, prior to exposing the coated glass fiber 206 to any dopant medium 116, apply UV light to the coated glass fiber 206 to at least partially cure the base material 114 of the fiber coating.

In some implementations, one or more process stages may be repeated. For example, one or more additional coating applicators 106, coating doping chambers 204, and/or UV light curing stations 108 may be provided following (e.g., downstream from) the UV light curing station 108. For example, while FIG. 2 illustrates one layer (e.g., one application) of fiber coating, the manufacturing system 200 may include multiple coatings, multiple dopings, and/or multiple UV light curing stations. Thus, another coating applicator, coating doping chamber, and UV light curing station may be provided for each layer of fiber coating. Multiple stations can be applied on a draw tower if multiple coating layers are desired.

The manufacturing system 200 provides an in situ process for modifying the refractive index of the fiber coating during manufacturing of the optical fiber (e.g., while the glass fiber 112 is being drawn from the glass furnace 102).

The manufacturing system 200 may include a precise delivery mechanism for introducing the doping element directly onto and/or into a polymer fiber coating. The manufacturing system 200 may include a controlled and monitored environment ensuring safety and optimal adjustment of doping parameters. The manufacturing system 200 may include a light curing station that cures a doped polymer fiber coating. The process may be continuously monitored to ensure consistent results and safety of operators and machines.

As indicated above, FIG. 2 is provided as an example. Other examples may differ from what is described with regard to FIG. 2. For example, in some implementations, one or more doping processes/stages described in connection with FIG. 1 may be integrated into the manufacturing system 200. Alternatively, one or more doping process/stages described in connection with FIG. 2 may be integrated into manufacturing system 100. For example, utilizing diverse methods of doping the fiber coating, in situ, may be used for accurately controlling and tailoring one or more optical properties of the fiber coating, including the refractive index.

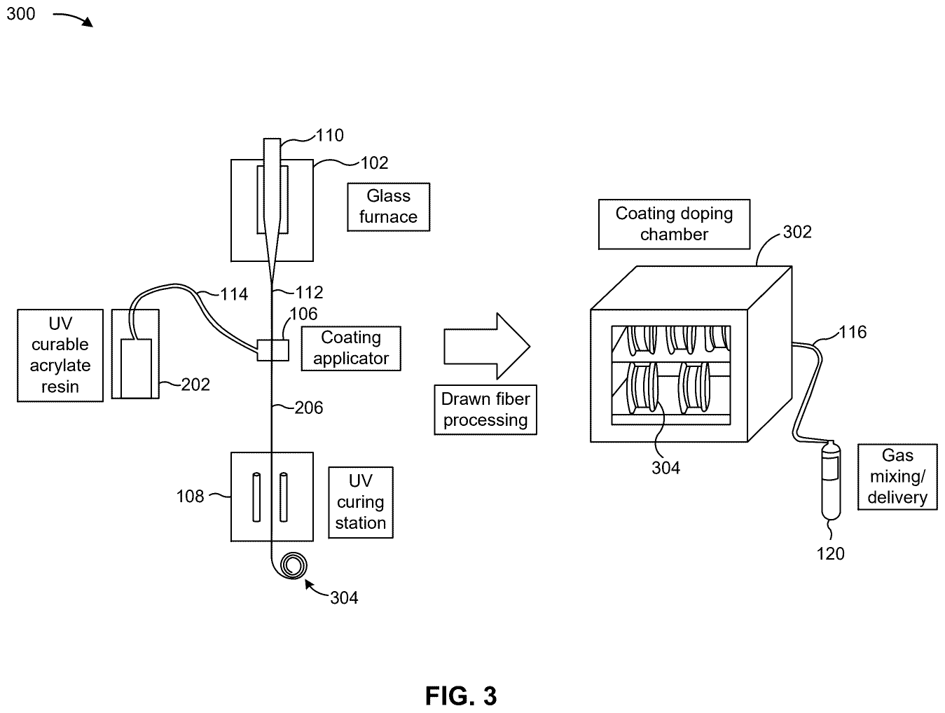

FIG. 3 shows a manufacturing system 300 for manufacturing an optical fiber according to one or more implementations. The manufacturing system 300 may include the glass furnace 102, the coating applicator 106, the UV light curing station 108, the delivery source 120, and the fiber coating source 202. In addition, the manufacturing system 300 may include a coating doping chamber 302.

The glass furnace 102 may heat the glass preform 110 from which the glass fiber 112 is to be drawn or pulled. The glass fiber 112 may be drawn from the glass preform 110 in a continuous manner.

The coating applicator 106 may be coupled to the fiber coating source 202 for receiving the base material 114 from the fiber coating source 202. The coating applicator 106 may, while the glass fiber 112 is being drawn from the glass furnace 102, apply a fiber coating (e.g., the base material 114) to the glass fiber 112 to form a coated glass fiber 206.

The UV light curing station 108 may be arranged downstream from the coating applicator 106 along the length of the glass fiber 112. While the glass fiber is being drawn from the glass furnace 102, the UV light curing station 108 may apply a UV light to the coated glass fiber 206 to at least partially cure the fiber coating. In some implementations, the fiber coating of the coated glass fiber 206 may be fully cured and the (cured) coated glass fiber may be spooled into a fiber spool 304. The fiber spool 304 may be placed in the coating doping chamber 302 in which the coated glass fiber of the fiber spool 304 is exposed to the dopant medium 116 containing one or more dopants by way of a gas chamber for a gas or an immersion receptacle for a liquid. Thus, the dopant medium 116 may be a gas or a liquid. As a result of being exposed to the dopant medium 116, the one or more dopants diffuse into the base material 114 of the fiber coating to modify the refractive index of the fiber coating to achieve a desired optical property. In addition, one or more fiber spools 304 may be placed in the coating doping chamber 302 for exposure to the dopant medium 116.

Due to the fiber coating being fully cured, longer exposure times may be needed to allow the one or more dopants to diffuse into the base material 114 of the fiber coating. However, manufacturing system 300 provides a precise delivery mechanism for introducing the doping element directly onto and/or into a polymer fiber coating, resulting in accurate and tailored optical properties. The manufacturing system 300 may include a controlled and monitored environment ensuring safety and optimal adjustment of doping parameters. The process may be continuously monitored to ensure consistent results and safety of operators and machines.

As indicated above, FIG. 3 is provided as an example. Other examples may differ from what is described with regard to FIG. 3. For example, in some implementations, one or more doping processes/stages described in connection with FIG. 1 or FIG. 2 may be integrated into the manufacturing system 300. Alternatively, the doping process/stage described in connection with FIG. 3 may be integrated into manufacturing system 100 and/or manufacturing system 200. For example, utilizing diverse methods of doping the fiber coating, in situ, may be used for accurately controlling and tailoring one or more optical properties of the fiber coating, including the refractive index.

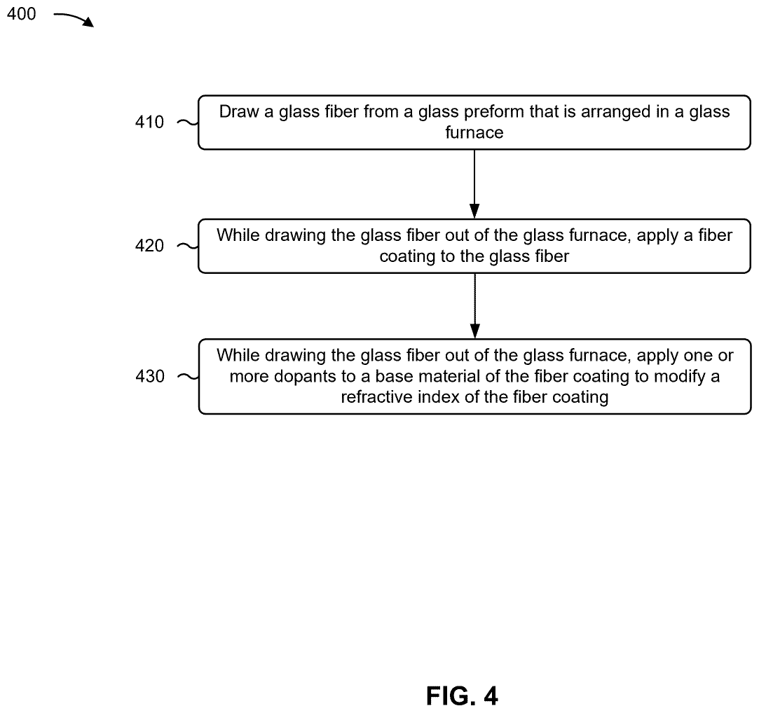

FIG. 4 is a flowchart of an example process 400 associated with in situ polymer coating refractive index modification. In some implementations, one or more process blocks of FIG. 4 are performed by a manufacturing system (e.g., manufacturing system 100 or 200). For example, one or more process blocks of FIG. 4 may be performed by one or more components or stations of manufacturing system 100 or 200, as described above.

As shown in FIG. 4, process 400 may include drawing a glass fiber from a glass preform that is arranged in a glass furnace (block 410).

As further shown in FIG. 4, process 400 may include, while drawing the glass fiber out of the glass furnace, applying a fiber coating to the glass fiber (block 420). For example, the coating applicator 106 may apply the fiber coating to the glass fiber, as described above.

As further shown in FIG. 4, process 400 may include, while drawing the glass fiber out of the glass furnace, applying one or more dopants to a base material of the fiber coating to modify a refractive index of the fiber coating (block 430). For example, the coating doping station 104, the coating doping chamber 204, and/or the coating doping chamber 210 may apply one or more dopants to the base material of the fiber coating to modify the refractive index of the fiber coating, as described above.

Process 400 may include additional implementations, such as any single implementation or any combination of implementations described below and/or in connection with one or more other processes described elsewhere herein.

In a first implementation, the fiber coating is a polymer coating.

In a second implementation, the fiber coating is an acrylate resin.

In a third implementation, the one or more dopants include at least one of fluorine, boron, phosphorous, or chlorine.

In a fourth implementation, the one or more dopants include at least one of fluorine, boron, or phosphorous to decrease the refractive index of the fiber coating.

In a fifth implementation, the one or more dopants include at least one of sulfur hexafluoride, silicon tetrafluoride, or titanium tetrachloride to increase the refractive index of the fiber coating.

In a sixth implementation, applying the one or more dopants to the base material of the fiber coating includes mixing the base material with a dopant medium of the one or more dopants to produce a doped base material, and wherein applying the fiber coating to the glass fiber includes applying, by a coating applicator, the doped base material to the glass fiber to form a coated glass fiber.

In a seventh implementation, the base material is a UV light-curable material, and wherein the process 400 further comprises, while drawing the glass fiber out of the glass furnace, applying, by a UV light curing station, UV light to the coated glass fiber to at least partially cure the fiber coating.

In an eighth implementation, applying the fiber coating to the glass fiber includes applying, by a coating applicator, the base material to the glass fiber to form a coated glass fiber, and wherein applying the one or more dopants to the base material of the fiber coating includes exposing the coated glass fiber to a gaseous dopant medium such that the one or more dopants diffuse into the base material of the fiber coating of the coated glass fiber.

In a ninth implementation, the base material is a UV light-curable material, and wherein the process 400 further comprises, while drawing the glass fiber out of the glass furnace and subsequent to applying the one or more dopants to the base material, applying, by a UV light curing station, UV light to the coated glass fiber to at least partially cure the fiber coating.

In a tenth implementation, applying the fiber coating to the glass fiber includes applying, by a coating applicator, the base material to the glass fiber to form a coated glass fiber, wherein the base material is a UV light-curable material, wherein the process 400 further comprises, while drawing the glass fiber out of the glass furnace, applying, by a UV light curing station, UV light to the coated glass fiber to at least partially cure the fiber coating, and wherein applying the one or more dopants to the base material of the fiber coating is performed subsequent to at least partially curing the fiber coating.

In an eleventh implementation, applying the one or more dopants to the base material of the fiber coating includes exposing the coated glass fiber to a gaseous dopant medium or a liquid dopant medium such that the one or more dopants diffuse into the base material of the fiber coating of the coated glass fiber.

Although FIG. 4 shows example blocks of process 400, in some implementations, process 400 includes additional blocks, fewer blocks, different blocks, or differently arranged blocks than those depicted in FIG. 4. Additionally, or alternatively, two or more of the blocks of process 400 may be performed in parallel.

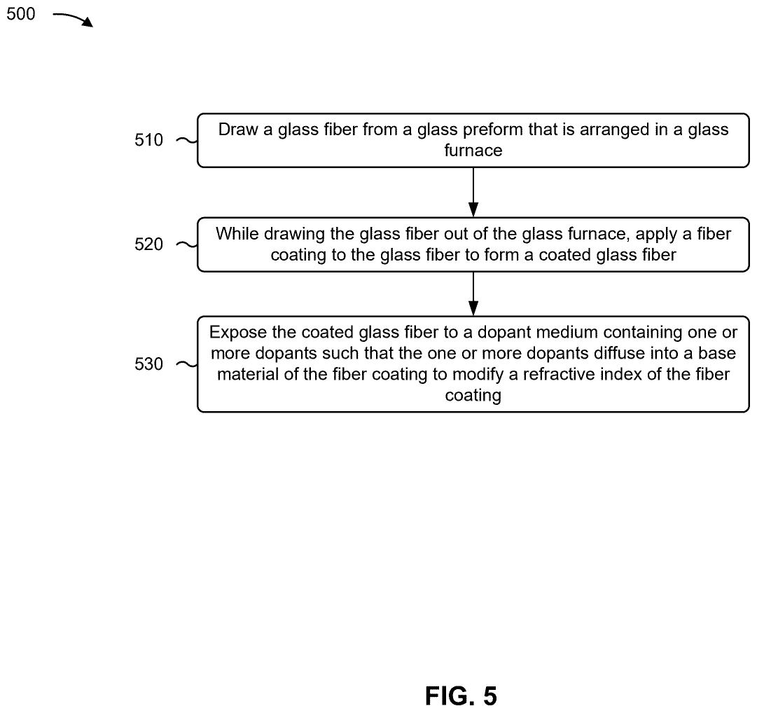

FIG. 5 is a flowchart of an example process 500 associated with in situ polymer coating refractive index modification. In some implementations, one or more process blocks of FIG. 5 are performed by a manufacturing system (e.g., manufacturing system 200 or 300). For example, one or more process blocks of FIG. 4 may be performed by one or more components or stations of manufacturing system 200 or 300, as described above.

As shown in FIG. 5, process 500 may include drawing a glass fiber from a glass preform that is arranged in a glass furnace (block 510).

As further shown in FIG. 5, process 500 may include, while drawing the glass fiber out of the glass furnace, applying a fiber coating to the glass fiber to form a coated glass fiber (block 520). For example, the coating applicator 106 may apply the fiber coating to the glass fiber, as described above.

As further shown in FIG. 5, process 500 may include exposing the coated glass fiber to a dopant medium containing one or more dopants such that the one or more dopants diffuse into a base material of the fiber coating to modify a refractive index of the fiber coating (block 530). For example, the coating doping chamber 204, the coating doping chamber 210, and/or the coating doping chamber 302 may expose the coated glass fiber to the dopant medium containing one or more dopants such that the one or more dopants diffuse into the base material of the fiber coating to modify the refractive index of the fiber coating, as described above.

Process 500 may include additional implementations, such as any single implementation or any combination of implementations described below and/or in connection with one or more other processes described elsewhere herein.

In a first implementation, the base material is a UV light-curable material, and the method further comprises, subsequent to exposing the coated glass fiber to the dopant medium, applying, by a UV light curing station, UV light to the coated glass fiber to at least partially cure the fiber coating. For example, the coating doping chamber 204 may expose the coated glass fiber to the dopant medium, and the UV light curing station 108 may subsequently apply UV light to the coated glass fiber.

In a second implementation, the base material is a UV light-curable material, and the method further comprises, prior to exposing the coated glass fiber to the dopant medium, applying, by a UV light curing station, UV light to the coated glass fiber to at least partially cure the fiber coating. For example, the UV light curing station 108 may apply UV light to the coated glass fiber prior to the coating doping chamber 210 or the coating doping chamber 302 exposes the coated glass fiber to the dopant medium.

Although FIG. 5 shows example blocks of process 500, in some implementations, process 500 includes additional blocks, fewer blocks, different blocks, or differently arranged blocks than those depicted in FIG. 5. Additionally, or alternatively, two or more of the blocks of process 500 may be performed in parallel.

The following provides an overview of some Aspects of the present disclosure:

Aspect 1: A method of manufacturing an optical fiber, the method comprising: drawing a glass fiber from a glass preform that is arranged in a glass furnace; and while drawing the glass fiber out of the glass furnace: applying a fiber coating to the glass fiber; and applying one or more dopants to a base material of the fiber coating to modify a refractive index of the fiber coating.

Aspect 2: The method of Aspect 1, wherein the fiber coating is a polymer coating.

Aspect 3: The method of any of Aspects 1-2, wherein the fiber coating is an acrylate resin.

Aspect 4: The method of any of Aspects 1-3, wherein the one or more dopants include at least one of fluorine, boron, phosphorous, or chlorine.

Aspect 5: The method of any of Aspects 1-4, wherein the one or more dopants include at least one of fluorine, boron, or phosphorous to decrease the refractive index of the fiber coating.

Aspect 6: The method of any of Aspects 1-5, wherein the one or more dopants include at least one of sulfur hexafluoride, silicon tetrafluoride, or titanium tetrachloride to increase the refractive index of the fiber coating.

Aspect 7: The method of any of Aspects 1-6, wherein applying the one or more dopants to the base material of the fiber coating includes mixing the base material with a dopant medium of the one or more dopants to produce a doped base material, and wherein applying the fiber coating to the glass fiber includes applying, by a coating applicator, the doped base material to the glass fiber to form a coated glass fiber.

Aspect 8: The method of Aspect 7, wherein the base material is an ultraviolet (UV) light-curable material, and wherein the method further comprises: while drawing the glass fiber out of the glass furnace, applying, by a UV light curing station, UV light to the coated glass fiber to at least partially cure the fiber coating.

Aspect 9: The method of any of Aspects 1-8, wherein applying the fiber coating to the glass fiber includes applying, by a coating applicator, the base material to the glass fiber to form a coated glass fiber, and wherein applying the one or more dopants to the base material of the fiber coating includes exposing the coated glass fiber to a gaseous dopant medium such that the one or more dopants diffuse into the base material of the fiber coating of the coated glass fiber.

Aspect 10: The method of Aspect 9, wherein the base material is an ultraviolet (UV) light-curable material, and wherein the method further comprises: while drawing the glass fiber out of the glass furnace and subsequent to applying the one or more dopants to the base material, applying, by a UV light curing station, UV light to the coated glass fiber to at least partially cure the fiber coating.

Aspect 11: The method of any of Aspects 1-10, wherein applying the fiber coating to the glass fiber includes applying, by a coating applicator, the base material to the glass fiber to form a coated glass fiber, wherein the base material is an ultraviolet (UV) light-curable material, wherein the method further comprises: while drawing the glass fiber out of the glass furnace, applying, by a UV light curing station, UV light to the coated glass fiber to at least partially cure the fiber coating, and wherein applying the one or more dopants to the base material of the fiber coating is performed subsequent to at least partially curing the fiber coating.

Aspect 12: The method of Aspect 11, wherein applying the one or more dopants to the base material of the fiber coating includes exposing the coated glass fiber to a gaseous dopant medium or a liquid dopant medium such that the one or more dopants diffuse into the base material of the fiber coating of the coated glass fiber.

Aspect 13: A method of manufacturing an optical fiber, the method comprising: drawing a glass fiber from a glass preform that is arranged in a glass furnace; while drawing the glass fiber out of the glass furnace, applying a fiber coating to the glass fiber to form a coated glass fiber; and exposing the coated glass fiber to a dopant medium containing one or more dopants such that the one or more dopants diffuse into a base material of the fiber coating to modify a refractive index of the fiber coating.

Aspect 14: The method of Aspect 13, wherein the base material is an ultraviolet (UV) light-curable material, wherein the method further comprises: subsequent to exposing the coated glass fiber to the dopant medium, applying, by a UV light curing station, UV light to the coated glass fiber to at least partially cure the fiber coating; or prior to exposing the coated glass fiber to the dopant medium, applying, by a UV light curing station, UV light to the coated glass fiber to at least partially cure the fiber coating.

Aspect 15: A manufacturing system for manufacturing an optical fiber, the manufacturing system comprising: a glass furnace configured to heat a glass preform from which a glass fiber is to be drawn; a coating doping station configured to mix a base material of a fiber coating with a dopant medium containing one or more dopants to produce a doped base material having a modified refractive index based on the one or more dopants; a coating applicator coupled to the coating doping station for receiving the doped base material from the coating doping station, wherein the coating applicator is configured to, while the glass fiber is being drawn from the glass furnace, apply the doped base material to the glass fiber to form a coated glass fiber; and an ultraviolet (UV) light curing station configured to at least partially cure the doped base material of the coated glass fiber.

Aspect 16: A manufacturing system for manufacturing an optical fiber, the manufacturing system comprising: a glass furnace configured to heat a glass preform from which a glass fiber is to be drawn; a coating applicator configured to, while the glass fiber is being drawn from the glass furnace, apply a fiber coating to the glass fiber to form a coated glass fiber; a coating doping chamber configured to, while the glass fiber is being drawn from the glass furnace, expose the coated glass fiber to a dopant medium containing one or more dopants such that the one or more dopants diffuse into a base material of the fiber coating to modify a refractive index of the fiber coating; and an ultraviolet (UV) light curing station arranged downstream from the coating doping chamber, wherein the UV light curing station is configured to apply a UV light to the coated glass fiber to at least partially cure the fiber coating.

Aspect 17: The manufacturing system of Aspect 16, wherein the one or more dopants include at least one of fluorine, boron, phosphorous, or chlorine.

Aspect 18: A manufacturing system for manufacturing an optical fiber, the manufacturing system comprising: a glass furnace configured to heat a glass preform from which a glass fiber is to be drawn; a coating applicator configured to, while the glass fiber is being drawn from the glass furnace, apply a fiber coating to the glass fiber to form a coated glass fiber; an ultraviolet (UV) light curing station arranged downstream from the coating applicator, wherein the UV light curing station is configured to apply a UV light to the coated glass fiber to at least partially cure the fiber coating; and a coating doping chamber arranged downstream from the UV light curing station, wherein the coating doping chamber is configured to expose the coated glass fiber to a dopant medium containing one or more dopants such that the one or more dopants diffuse into a base material of the fiber coating to modify a refractive index of the fiber coating.

Aspect 19: The manufacturing system of Aspect 18, wherein the coating doping chamber is configured to expose the coated glass fiber to the dopant medium while the glass fiber is being drawn from the glass furnace.

Aspect 20: The manufacturing system of any of Aspects 18-19, wherein the coating doping chamber is configured to expose a spool of the coated glass fiber to the dopant medium.

Aspect 21: A system configured to perform one or more operations recited in one or more of Aspects 1-20.

Aspect 22: An apparatus comprising means for performing one or more operations recited in one or more of Aspects 1-20.

The foregoing disclosure provides illustration and description, but is not intended to be exhaustive or to limit the implementations to the precise forms disclosed. Modifications and variations may be made in light of the above disclosure or may be acquired from practice of the implementations. Furthermore, any of the implementations described herein may be combined unless the foregoing disclosure expressly provides a reason that one or more implementations may not be combined.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”). Further, spatially relative terms, such as “below,” “lower,” “above,” “upper,” and the like, may be used herein for ease of description to describe one element or feature's relationship to another element(s) or feature(s) as illustrated in the figures. The spatially relative terms are intended to encompass different orientations of the apparatus, device, and/or element in use or operation in addition to the orientation depicted in the figures. The apparatus may be otherwise oriented (rotated 90 degrees or at other orientations) and the spatially relative descriptors used herein may likewise be interpreted accordingly.

What is claimed is:

1. A method of manufacturing an optical fiber, the method comprising:
drawing a glass fiber from a glass preform that is arranged in a glass furnace; and
while drawing the glass fiber out of the glass furnace:
applying a fiber coating to the glass fiber; and
applying one or more dopants to a base material of the fiber coating to modify a refractive index of the fiber coating.

2. The method of claim 1, wherein the fiber coating is a polymer coating.

3. The method of claim 1, wherein the fiber coating is an acrylate resin.

4. The method of claim 1, wherein the one or more dopants include at least one of fluorine, boron, phosphorous, or chlorine.

5. The method of claim 1, wherein the one or more dopants include at least one of fluorine, boron, or phosphorous to decrease the refractive index of the fiber coating.

6. The method of claim 1, wherein the one or more dopants include at least one of sulfur hexafluoride, silicon tetrafluoride, or titanium tetrachloride to increase the refractive index of the fiber coating.

7. The method of claim 1, wherein applying the one or more dopants to the base material of the fiber coating includes mixing the base material with a dopant medium of the one or more dopants to produce a doped base material, and
wherein applying the fiber coating to the glass fiber includes applying, by a coating applicator, the doped base material to the glass fiber to form a coated glass fiber.

8. The method of claim 7, wherein the base material is an ultraviolet (UV) light-curable material, and
wherein the method further comprises:
while drawing the glass fiber out of the glass furnace, applying, by a UV light curing station, UV light to the coated glass fiber to at least partially cure the fiber coating.

9. The method of claim 1, wherein applying the fiber coating to the glass fiber includes applying, by a coating applicator, the base material to the glass fiber to form a coated glass fiber, and
wherein applying the one or more dopants to the base material of the fiber coating includes exposing the coated glass fiber to a gaseous dopant medium such that the one or more dopants diffuse into the base material of the fiber coating of the coated glass fiber.

10. The method of claim 9, wherein the base material is an ultraviolet (UV) light-curable material, and
wherein the method further comprises:
while drawing the glass fiber out of the glass furnace and subsequent to applying the one or more dopants to the base material, applying, by a UV light curing station, UV light to the coated glass fiber to at least partially cure the fiber coating.

11. The method of claim 1, wherein applying the fiber coating to the glass fiber includes applying, by a coating applicator, the base material to the glass fiber to form a coated glass fiber,
wherein the base material is an ultraviolet (UV) light-curable material,
wherein the method further comprises:
while drawing the glass fiber out of the glass furnace, applying, by a UV light curing station, UV light to the coated glass fiber to at least partially cure the fiber coating, and
wherein applying the one or more dopants to the base material of the fiber coating is performed subsequent to at least partially curing the fiber coating.

12. The method of claim 11, wherein applying the one or more dopants to the base material of the fiber coating includes exposing the coated glass fiber to a gaseous dopant medium or a liquid dopant medium such that the one or more dopants diffuse into the base material of the fiber coating of the coated glass fiber.

13. A method of manufacturing an optical fiber, the method comprising:
drawing a glass fiber from a glass preform that is arranged in a glass furnace;
while drawing the glass fiber out of the glass furnace, applying a fiber coating to the glass fiber to form a coated glass fiber; and
exposing the coated glass fiber to a dopant medium containing one or more dopants such that the one or more dopants diffuse into a base material of the fiber coating to modify a refractive index of the fiber coating.

14. The method of claim 13, wherein the base material is an ultraviolet (UV) light-curable material,
wherein the method further comprises:
subsequent to exposing the coated glass fiber to the dopant medium, applying, by a UV light curing station, UV light to the coated glass fiber to at least partially cure the fiber coating; or
prior to exposing the coated glass fiber to the dopant medium, applying, by a UV light curing station, UV light to the coated glass fiber to at least partially cure the fiber coating.

15. A manufacturing system for manufacturing an optical fiber, the manufacturing system comprising:
a glass furnace configured to heat a glass preform from which a glass fiber is to be drawn;
a coating doping station configured to mix a base material of a fiber coating with a dopant medium containing one or more dopants to produce a doped base material having a modified refractive index based on the one or more dopants;
a coating applicator coupled to the coating doping station for receiving the doped base material from the coating doping station, wherein the coating applicator is configured to, while the glass fiber is being drawn from the glass furnace, apply the doped base material to the glass fiber to form a coated glass fiber; and
an ultraviolet (UV) light curing station configured to at least partially cure the doped base material of the coated glass fiber.

16. A manufacturing system for manufacturing an optical fiber, the manufacturing system comprising:
a glass furnace configured to heat a glass preform from which a glass fiber is to be drawn;
a coating applicator configured to, while the glass fiber is being drawn from the glass furnace, apply a fiber coating to the glass fiber to form a coated glass fiber;
a coating doping chamber configured to, while the glass fiber is being drawn from the glass furnace, expose the coated glass fiber to a dopant medium containing one or more dopants such that the one or more dopants diffuse into a base material of the fiber coating to modify a refractive index of the fiber coating; and
an ultraviolet (UV) light curing station arranged downstream from the coating doping chamber, wherein the UV light curing station is configured to apply a UV light to the coated glass fiber to at least partially cure the fiber coating.

17. The manufacturing system of claim 16, wherein the one or more dopants include at least one of fluorine, boron, phosphorous, or chlorine.

18. A manufacturing system for manufacturing an optical fiber, the manufacturing system comprising:
a glass furnace configured to heat a glass preform from which a glass fiber is to be drawn;
a coating applicator configured to, while the glass fiber is being drawn from the glass furnace, apply a fiber coating to the glass fiber to form a coated glass fiber;
an ultraviolet (UV) light curing station arranged downstream from the coating applicator, wherein the UV light curing station is configured to apply a UV light to the coated glass fiber to at least partially cure the fiber coating; and
a coating doping chamber arranged downstream from the UV light curing station, wherein the coating doping chamber is configured to expose the coated glass fiber to a dopant medium containing one or more dopants such that the one or more dopants diffuse into a base material of the fiber coating to modify a refractive index of the fiber coating.

19. The manufacturing system of claim 18, wherein the coating doping chamber is configured to expose the coated glass fiber to the dopant medium while the glass fiber is being drawn from the glass furnace.

20. The manufacturing system of claim 18, wherein the coating doping chamber is configured to expose a spool of the coated glass fiber to the dopant medium.
